(19) United States
(12) Patent Application Publication
(10) Pub. No.: US 2018/0324475 A1
(43) Pub. Date: Nov. 8, 2018

(54) TRANSMISSION DEVICE, TRANSMISSION METHOD, RECEPTION DEVICE, RECEPTION METHOD, AND TRANSMISSION/RECEPTION SYSTEM

(71) Applicant: SONY CORPORATION, TOKYO (JP)

(72) Inventors: SHINNOSUKE USAMI, TOKYO (JP); TETSUO KANEKO, KANAGAWA (JP); YASUHIRO IIZUKA, KANAGAWA (JP); KAZUHIRO UCHIDA, KANAGAWA (JP); SHIGEO NAKATSUKA, TOKYO (JP)

(21) Appl. No.: 15/773,080

(22) PCT Filed: Nov. 16, 2016
(86) PCT No.: PCT/JP2016/083985

§ 371 Date: May 2, 2018

(30) Foreign Application Priority Data
Nov. 17, 2015 (JP) 2015-224621

(51) Int. Cl. H04N 21/2343; H04N 5/247; H04N 21/431

(52) U.S. Cl. CPC H04N 21/234345; H04N 21/4318; H04N 21/234318; H04N 5/247

(57) ABSTRACT

A usage amount of a network bandwidth is kept small such that the network bandwidth is utilized. Data items of images captured by imaging with a plurality of cameras in a manner that adjacent ones of the captured images overlap with each other are stored into a storage unit. Cutting-out-target-region information items for a predetermined number of cameras selected from the plurality of cameras are received from an external device via a network. On the basis of the cutting-out-target-region information items for the predetermined number of cameras, data items of images of cutting-out-target regions are cut out from corresponding ones of the data items of the images captured by the plurality of cameras, the data items of the captured images being stored in the storage unit, and are transmitted to the external device via the network.

### TECHNICAL FIELD

The present technology relates to a transmission device, a transmission method, a reception device, a reception method, and a transmission/reception system. More specifically, the present technology relates to, for example, a transmission device that processes data items of images captured by imaging with a plurality of cameras.

### BACKGROUND ART

Hitherto, there has been a technology as disclosed in Patent Literature 1, which includes transmitting data items of images captured by a plurality of cameras to a reception side via a network, cutting out, on the reception side, data items of images corresponding to a display region from the data items of the plurality of captured images, executing a stitching process thereon so as to generate a composite image, and displaying the image.

### CITATION LIST

### Patent Literature

Patent Literature 1: Japanese Patent Application Laid-open No. 2008-225600

### DISCLOSURE OF INVENTION

### Technical Problem

In the technology disclosed in Patent Literature 1, all the data items of the images captured by the plurality of cameras are transmitted to the reception side. Thus, a usage amount of a network bandwidth increases in proportion to the number of cameras.

It is an object of the present technology to keep small a usage amount of a network bandwidth such that the network bandwidth is utilized.

### Solution to Problem

A concept of the present technology lies in a transmission device including:

a storage unit that stores data items of images captured by imaging with a plurality of cameras in a manner that adjacent ones of the captured images overlap with each other;

an information reception unit that receives, from an external device via a network, cutting-out-target-region information items for a predetermined number of cameras selected from the plurality of cameras; and

an image-data transmission unit that
cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit, and
transmits the data items of the images of the cutting-out-target regions to the external device via the network.

According to the present technology, the storage unit stores the data items of the images captured by the imaging with the plurality of cameras in the manner that the adjacent ones of the captured images overlap with each other. The information reception unit receives, from the external device via the network, the cutting-out-target-region information items for the predetermined number of cameras selected from the plurality of cameras. The image-data transmission unit cuts out, on the basis of the cutting-out-target-region information items for the predetermined number of cameras, the data items of the images of the cutting-out-target regions from the corresponding ones of the data items of the images captured by the plurality of cameras, the data items of the captured images being stored in the storage unit. Then, the image-data transmission unit transmits the data items of the images of the cutting-out-target regions to the external device via the network.

In this way, according to the present technology, not all the data items of the images captured by the plurality of cameras, but only the data items of the images of the cutting-out-target regions from the predetermined number of cameras are transmitted to the external device via the network on the basis of the information items from the external device. With this, a usage amount of a network bandwidth can be kept small. As a result, the network bandwidth can be utilized.

Note that, according to the present technology, for example, the image-data transmission unit may transmit, to the external device, the data items of the images of the cutting-out-target regions from the predetermined number of cameras after execution of a compression-coding process on the data items of the images of the cutting-out-target regions. When the compression-coding process is executed in this way, the usage amount of the network bandwidth can be kept much smaller.

Further, another concept of the present technology lies in a transmission device including:
a plurality of cameras that perform imaging in a manner that adjacent ones of captured images overlap with each other; and
a plurality of adapters provided to correspond respectively to the plurality of cameras,
the plurality of adapters respectively including
   storage units that store data items of the images captured by imaging with corresponding ones of the plurality of cameras,
   information reception units that receive, from an external device via a network, cutting-out-target-region information items for the corresponding ones of the plurality of cameras, and
   image-data transmission units that
      cut out, on the basis of the cutting-out-target-region information items, data items of images of cutting-out-target regions from corresponding ones of the data items of the captured images, the data items of the captured images being stored in the storage units, and
      transmit the data items of the images of the cutting-out-target regions to the external device via the network.

According to the present technology, the plurality of cameras and the plurality of adapters provided to correspond respectively to the plurality of cameras are provided. The plurality of cameras perform the imaging in the manner that the adjacent ones of the captured images overlap with each other. The plurality of adapters respectively include the storage units, the information reception units, and the image-data transmission units.

The storage units store the data items of the images captured by the imaging with the corresponding ones of the plurality of cameras. The information reception units receive, from the external device via the network, the cutting-out-target-region information items for the corresponding ones of the plurality of cameras. Then, the image-data transmission units cut out, on the basis of the cutting-out-target-region information items, the data items of the images of the cutting-out-target regions from the corresponding ones of the data items of the captured images, the data items of the captured images being stored in the storage units. Then, the image-data transmission units transmit the data items of the images of the cutting-out-target regions to the external device via the network.

In this way, according to the present technology, not all the images captured by the plurality of cameras, but only the data items of the images of the cutting-out-target regions from the selected predetermined number of cameras are transmitted to the external device via the network on the basis of the information items from the external device. With this, the usage amount of the network bandwidth can be kept small. As a result, the network bandwidth can be utilized.

Still another concept of the present technology lies in a transmission device including
a plurality of cameras that perform imaging in a manner that adjacent ones of captured images overlap with each other,
the plurality of cameras respectively including
   information reception units that receive cutting-out-target-region information items from an external device via a network, and
   image-data transmission units that
      cut out, on the basis of the cutting-out-target-region information items, data items of images of cutting-out-target regions from data items of the captured images, and
      transmit the data items of the images of the cutting-out-target regions to the external device via the network.

According to the present technology, the plurality of cameras are provided. The plurality of cameras perform the imaging in the manner that the adjacent ones of the captured images overlap with each other. The plurality of cameras respectively include the information reception units and the image-data transmission units. The information reception units receive the cutting-out-target-region information items from the external device via the network. The image-data transmission units cut out, on the basis of the cutting-out-target-region information items, the data items of the images of the cutting-out-target regions from the data items of the captured images. Then, the image-data transmission units transmit the data items of the images of the cutting-out-target regions to the external device via the network.

In this way, according to the present technology, not all the images captured by the plurality of cameras, but only the data items of the images of the cutting-out-target regions from the selected predetermined number of cameras are transmitted to the external device via the network on the basis of the information items from the external device. With this, the usage amount of the network bandwidth can be kept small. As a result, the network bandwidth can be utilized.

Yet another concept of the present technology lies in a transmission device including
a plurality of servers provided to correspond respectively to a plurality of cameras that perform imaging in a manner that adjacent ones of captured images overlap with each other,
the plurality of servers respectively including
   storage units that store data items of the images captured by imaging with corresponding ones of the plurality of cameras,
   information reception units that receive, from an external device via a network, cutting-out-target-region information items for the corresponding ones of the plurality of cameras, and
   image-data transmission units that
      cut out, on the basis of the cutting-out-target-region information items, data items of images of cutting-out-target regions from the data items of the captured images, the data items of the captured images being stored in the storage units, and
      transmit the data items of the images of the cutting-out-target regions to the external device via the network.

According to the present technology, the plurality of servers are provided. The plurality of servers are provided to correspond respectively to the plurality of cameras that perform the imaging in the manner that the adjacent ones of the captured images overlap with each other. The plurality of servers respectively include the storage units, the information reception units, and the image-data transmission units.

The storage units store the data items of the images captured by the imaging with the corresponding ones of the plurality of cameras. The information reception units receive, from the external device via the network, the cutting-out-target-region information items for the corresponding ones of the plurality of cameras. Then, the image-data transmission units cut out, on the basis of the cutting-out-target-region information items, the data items of the images of the cutting-out-target regions from the data items of the captured images, the data items of the captured images being stored in the storage units. Then, the image-data transmission units transmit the data items of the images of the cutting-out-target regions to the external device via the network.

In this way, according to the present technology, not all the images captured by the plurality of cameras, but only the data items of the images of the cutting-out-target regions from the selected predetermined number of cameras are transmitted to the external device via the network on the basis of the information items from the external device. With this, the usage amount of the network bandwidth can be kept small. As a result, the network bandwidth can be utilized.

Further, yet another concept of the present technology lies in a reception device including:
a cutting-out-target-region determination unit that
   sets a display region in a composite image formed of images captured by imaging with a plurality of cameras in a manner that adjacent ones of the captured images overlap with each other, and
   determines regions in images captured by a predetermined number of cameras as cutting-out-target regions, the regions in the captured images including at least regions that overlap with the display region;
an information transmission unit that transmits cutting-out-target-region information items for the predetermined number of cameras to an external device via a network;
an image-data reception unit that receives, from the external device via the network, data items of images of the cutting-out-target regions from the predetermined number of cameras; and
an image-data processing unit that executes a stitching process on the received data items of the images of the cutting-out-target regions from the predetermined number of cameras to generate a data item of an image in the composite image, the image in the composite image corresponding to the display region.

According to the present technology, the cutting-out-target-region determination unit sets the display region in the composite image formed of the images captured by the imaging with the plurality of cameras in the manner that the adjacent ones of the captured images overlap with each other. Then, the cutting-out-target-region determination unit determines the regions in the images captured by the predetermined number of cameras as the cutting-out-target regions, the regions in the captured images including at least the regions that overlap with the display region.

The cutting-out-target-region determination unit may set, for example, the display region on the basis of control information for the display region, the control information being supplied from a display device that displays an image generated from the data item of the image in the composite image. In this case, the display device may, for example, be a head mounted display, and the control information for the display region may be orientation information. In addition, in this case, the display device may, for example, be a personal computer, a tablet, or a smartphone, and the control information for the display region may be movement information based on an operation by a user.

The information transmission unit transmits the cutting-out-target-region information items for the predetermined number of cameras to the external device via the network. The image-data reception unit receives, from the external device via the network, the data items of the images of the cutting-out-target regions from the predetermined number of cameras. Then, the image-data processing unit executes the stitching process on the received data items of the images of the cutting-out-target regions from the predetermined number of cameras to generate the data item of the image in the composite image, the image in the composite image corresponding to the display region.

The received data items of the images of the cutting-out-target regions from the predetermined number of cameras may, for example, have been subjected to a compression-coding process, and the image-data processing unit may, for example, execute a compression-decoding process on the data items of the images of the cutting-out-target regions from the predetermined number of cameras, and then execute the stitching process to generate the data item of the image in the composite image, the image in the composite image corresponding to the display region.

In this way, according to the present technology, the cutting-out-target-region information items for the predetermined number of cameras, which correspond to the display region, are transmitted to the external device, and only the data items of the images of the cutting-out-target regions from the predetermined number of cameras are received from the external device via the network. With this, the usage amount of the network bandwidth can be kept small. As a result, the network bandwidth can be utilized. Further, according to the present technology, the stitching process is executed on the received data items of the images of the cutting-out-target regions from the predetermined number of cameras such that the data item of the image in the composite image, which corresponds to the display region, is generated. In this way, the stitching process is executed only on the parts corresponding to the display region, and hence processing load can be reduced.

Further, yet another concept of the present technology lies in a transmission device including:
a storage unit that stores data items of images captured by imaging with a plurality of cameras in a manner that adjacent ones of the captured images overlap with each other;
an information reception unit that receives, from an external device via a network, cutting-out-target-region information items for a predetermined number of cameras selected from the plurality of cameras;
an image-data cutting-out unit that cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit;
an image-data processing unit that executes a stitching process on the data items of the images of the cutting-out-target regions from the predetermined number of cameras to generate a data item of an image in a composite image; and
an image-data transmission unit that transmits the data item of the image in the composite image to the external device via the network.

According to the present technology, the storage unit stores the data items of the images captured by the imaging with the plurality of cameras in the manner that the adjacent ones of the captured images overlap with each other. The information reception unit receives, from the external device via the network, the cutting-out-target-region information items for the predetermined number of cameras selected from the plurality of cameras.

The image-data cutting-out unit cuts out, on the basis of the cutting-out-target-region information items for the predetermined number of cameras, the data items of the images of the cutting-out-target regions from the corresponding ones of the data items of the images captured by the plurality of cameras, the data items of the captured images being stored in the storage unit. The image-data processing unit executes the stitching process on the data items of the images of the cutting-out-target regions from the predetermined number of cameras to generate the data item of the image in the composite image. Then, the image-data transmission unit transmits the data item of the image in the composite image to the external device via the network.

In this way, according to the present technology, not all the images captured by the plurality of cameras, but the data item of the image in the composite image, which is generated by executing the stitching process on the data items of the images of the cutting-out-target regions from the selected predetermined number of cameras, is transmitted to the external device via the network on the basis of the information items from the external device. With this, the usage amount of the network bandwidth can be kept small. As a result, the network bandwidth can be utilized, and processing load on the external device can be reduced.

Further, yet another concept of the present technology lies in a reception device including:
a cutting-out-target-region determination unit that
   sets a display region in a composite image formed of images captured by imaging with a plurality of cameras in a manner that adjacent ones of the captured images overlap with each other, and
   determines regions in images captured by a predetermined number of cameras as cutting-out-target regions, the regions in the captured images including at least regions that overlap with the display region;
an information transmission unit that transmits cutting-out-target-region information items for the predetermined number of cameras to an external device via a network; and
an image-data reception unit that receives, from the external device via the network, a data item of an image in the composite image, the image in the composite image having been generated by execution of a stitching process on data items of images of the cutting-out-target regions from the predetermined number of cameras.

According to the present technology, the cutting-out-target-region determination unit sets the display region in the composite image formed of the images captured by imaging with the plurality of cameras in the manner that the adjacent ones of the captured images overlap with each other. Then, the cutting-out-target-region determination unit determines the regions in the images captured by the predetermined number of cameras as the cutting-out-target regions, the regions in the captured images including at least the regions that overlap with the display region. The information transmission unit transmits the cutting-out-target-region information items for the predetermined number of cameras to the external device via the network. The image-data reception unit receives, via the network, the data item of the image in the composite image, the image in the composite image having been generated by the execution of the stitching process on the data items of the images of the cutting-out-target regions from the predetermined number of cameras.

In this way, according to the present technology, the cutting-out-target-region information items for the predetermined number of cameras, which correspond to the display region, are transmitted to the external device, and the data item of the image in the composite image, which is generated by executing the stitching process on the data items of the images of the cutting-out-target regions from the predetermined number of cameras, is received from the external device. With this, the usage amount of the network bandwidth can be kept small. As a result, the network bandwidth can be utilized. In addition, the stitching process need not be executed, and hence processing load can be reduced.

### Advantageous Effects of Invention

According to the present technology, the usage amount of the network bandwidth can be kept small irrespective of the number of cameras. With this, the network bandwidth can be utilized. Note that, the advantaged disclosed herein are merely illustrative, and hence are not limited thereto. In addition, other advantages may be additionally provided.

### BRIEF DESCRIPTION OF DRAWINGS

FIG. 1 A block diagram showing a configuration example of a transmission/reception system according to an embodiment.

FIG. 2 An explanatory illustration of an arrangement of cameras of the transmission/reception system.

FIG. 3 A block diagram showing a configuration example of an adapter.

FIG. 4 An illustration of an example of images captured by the plurality of cameras, and a composite image formed of those captured images.

FIG. 5 An explanatory illustration of how a display region is set and how cutting-out-target regions are determined.

FIG. 6 A block diagram showing a configuration example of a subsequent processing device.

FIG. 7 A schematic flowchart showing operations in the transmission/reception system.

FIG. 8 An explanatory chart showing an advantage of reducing a usage amount of a network bandwidth.

FIG. 9 A block diagram showing another configuration example of the transmission/reception system.

FIG. 10 A block diagram showing still another configuration example of the transmission/reception system.

FIG. 11 A block diagram showing yet another configuration example of the transmission/reception system.

FIG. 12 A block diagram showing yet another configuration example of the transmission/reception system.

FIG. 13 A block diagram showing yet another configuration example of the transmission/reception system.

FIG. 14 An explanatory diagram showing other examples of a display device that is connected to the subsequent processing device.

FIG. 15 An illustration of an example of a displayed screen in cases where the display device is, for example, a personal computer.

FIG. 16 A block diagram showing yet another configuration example of the transmission/reception system.

FIG. 17 An illustration of an example of a display region that is set in a composite image formed of images captured by a plurality of cameras.

### MODE FOR CARRYING OUT THE INVENTION

Now, an embodiment for carrying out the invention (hereinafter, abbreviated as “embodiment”) is described. Note that, the description is made in the following order.

1. Embodiment

2. Modification

### 1. First Embodiment

[Configuration Example of Transmission/Reception System]

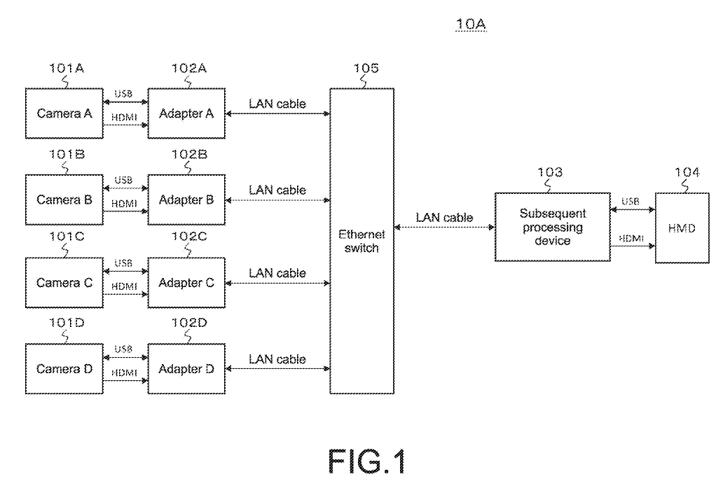

FIG. 1 shows a configuration example of a transmission/reception system 10A according to an embodiment. In the configuration of this transmission/reception system 10A, a transmission side and a reception side are connected to each other via a network.

The transmission side is described. The transmission/reception system 10A includes, on the transmission side, a plurality of, specifically, four cameras (camcorders) of a camera (camera A) 101A, a camera (camera B) 101B, a camera (camera C) 101C, and a camera (camera D) 101D. In this case, the cameras are each, for example, an HD camera for generating data items of full HD images.

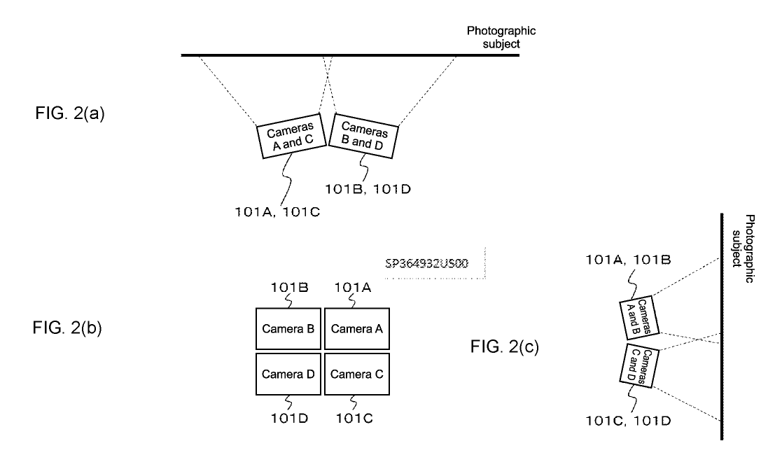

The cameras 101A, 101B, 101C, and 101D are arranged in, for example, a two-by-two matrix in a horizontal direction and a perpendicular direction. FIG. 2 illustrates an arrangement pattern of the cameras. (a) of FIG. 2 is an illustration of a camera arrangement as viewed from above, (b) of FIG. 2 is another illustration of the camera arrangement as viewed from front, and (c) of FIG. 2 is still another illustration of the camera arrangement as viewed from a lateral side. As illustrated in (a) and (c) of FIG. 2, the cameras perform imaging in a manner that images to be captured by adjacent ones of the cameras overlap with each other.

Further, the transmission/reception system 10A includes, on the transmission side, adapters 102A to 102D provided correspondingly to the cameras 101A to 101D, respectively. The adapters 102A to 102D are connected respectively to the cameras 101A to 101D via USB (Universal Serial Bus) cables and HDMI (High-Definition Multimedia Interface) cables. In addition, the adapters 102A to 102D are connected to an Ethernet switch 105 via respective LAN cables. Note that, “HDMI” and “Ethernet” are each a trademark.

The adapters receive data items of images captured by imaging with the corresponding cameras, and store these data items into storage units. Further, the adapters receive cutting-out-target-region information items for the corresponding cameras from the reception side via the network. In addition, on the basis of the cutting-out-target-region information items, the adapters cut out data items of images of cutting-out-target regions from the data items of the captured images stored in the storage units, and transmit the data items of these cut-out images to the reception side via the network.

The cameras (and adapters) are synchronized with each other using, for example, PTP (IEEE 1588 Precision Time Protocol) via the network. In this way, the cameras can be subjected to V-synchronization via the network. With this system, the cameras (and adapters) perform imaging and process the data items of the captured images while maintaining the V-synchronization.

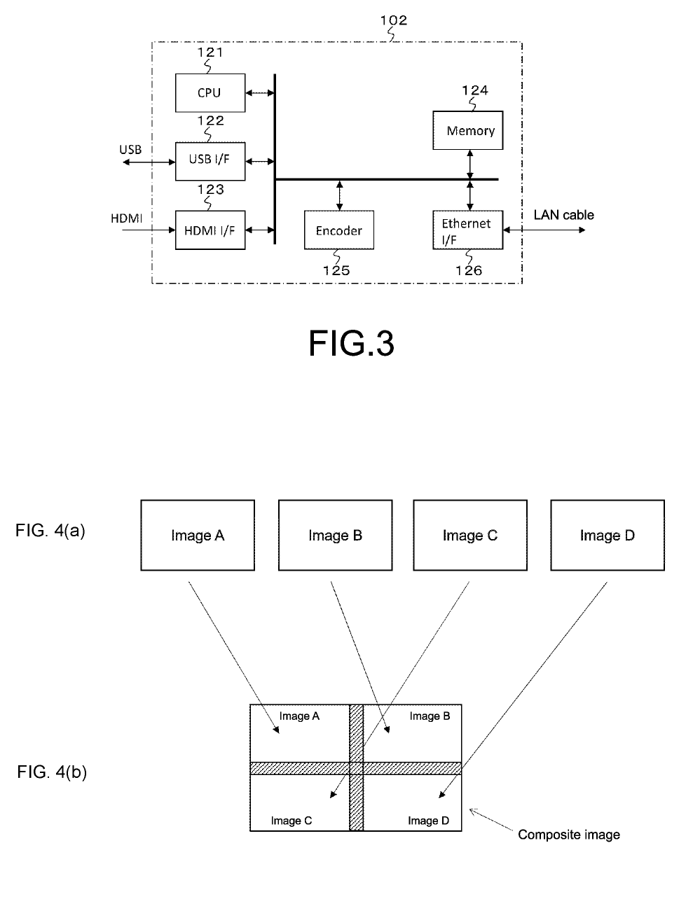

FIG. 3 shows a configuration example of the adapter 102 (102A to 102D). The adapter 102 includes a CPU 121, a USB interface 122, an HDMI interface 123, a memory 124, an encoder 125, and an Ethernet interface 126.

The CPU 121 controls operations of the units in the adapter 102. The USB interface 122 is an interface for performing communication between the adapter 102 and the camera. In this USB communication, an instruction command issued on the reception side with respect to the camera is transmitted to the camera. Further, this USB communication may be used instead of HDMI transmission described below for receiving the data items of the captured images from the camera.

The HDMI interface 123 is an interface for performing the HDMI data transmission between the adapter 102 and the camera. In this case, the camera corresponds to a source device, and the adapter 102 corresponds to a sink device. In this HDMI data transmission, the data items of the captured images, which are transmitted from the camera via HDMI, are received.

The memory 124 serves as the storage unit. The memory 124 stores the data items of the captured images, which are transmitted from the camera via the HDMI data transmission or the USB communication. The Ethernet interface 126 is an interface for establishing connection to the network, specifically, to a LAN (Local Area Network). This Ethernet interface 126 receives, via the network, the above-mentioned instruction command issued on the reception side with respect to the camera.

Further, this Ethernet interface 126 receives the cutting-out-target-region information item for the corresponding camera, which is transmitted from the reception side via the network. Specifically, the Ethernet interface 126 receives, from the reception side, an instruction packet containing the cutting-out-target-region information item.

Note that, the cutting-out-target region refers to a region that is cut out from the image captured by the corresponding camera and includes at least a region that overlaps with a display region to be set in a composite image formed of the images captured by the cameras 101A to 101D. In this case, when the image captured by the corresponding camera does not include the region that overlaps with the display region, the cutting-out-target-region information item is not transmitted from the reception side. This cutting-out-target-region information item is described in further detail together with description of the reception side below.

Further, this Ethernet interface 126 transmits, to the reception side via the network, the data item of the image of the cutting-out-target region, which is cut out from the data item of the captured image stored in the memory 124 on the basis of the cutting-out-target-region information item.

The encoder 125 cuts out, on the basis of the cutting-out-target-region information item received by the Ethernet interface 126, the data item of the image of the cutting-out-target region from the data item of the captured image stored in the memory 124. With this, the encoder 125 generates the image data item to be transmitted to the reception side. Note that, when necessary, this encoder 125 executes a process of compression-coding the data item of the image of this cutting-out-target region with, for example, JPEG2000 or JPEG so as to reduce a data amount.

Next, referring back to FIG. 1, the receptions side is described. The transmission/reception system 10A includes, on the reception side, a subsequent processing device 103, and a head mounted display (HMD) 104 as a display device. The subsequent processing device 103 is connected to the Ethernet switch 105 via a LAN cable. The head mounted display 104 is connected to the subsequent processing device 103 via a USB cable and an HDMI cable.

The subsequent processing device 103 sets the display region in the composite image formed of the images captured by the cameras 101A to 101D, and determines regions in images captured by a predetermined number of cameras as the cutting-out-target regions, the regions including at least the regions that overlap with the display region. For example, (a) of FIG. 4 illustrates the images captured by the cameras 101A to 101D. In this case, a “moving image A” corresponds to the image captured by the camera 101A, a “moving image B” corresponds to the image captured by the camera 101B, a “moving image C” corresponds to the image captured by the camera 101C, and a “moving image D” corresponds to the image captured by the camera 101D.

(b) of FIG. 4 illustrates an example of the composite image formed of the images captured by the cameras 101A to 101D. In this case, overlapping parts that are generated in the images captured by the cameras 101A to 101D overlap with each other. In the illustrated example, hatched regions indicate the overlapping state. As described above, the cameras 101A to 101D are each an HD camera, and hence a 4K image is generated as the composite image.

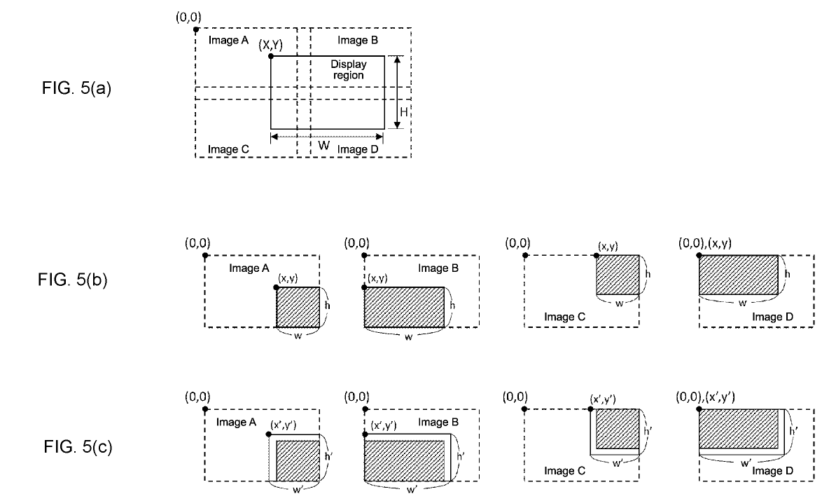

(a) of FIG. 5 illustrates an example of the display region set in the composite image. The subsequent processing device 103 sets the display region on the basis of control information for the display region, which is supplied from the display device. In this embodiment, the head mounted display 104 serves as the display device, and orientation information is supplied as the control information for the display region from the head mounted display 105 to the subsequent processing device 103. The head mounted display 104 acquires this orientation information with, for example, a gyroscopic sensor and an acceleration sensor.

The display region set in the composite image is defined by, for example, reference coordinates (X, Y) being coordinates of an upper-left end, a height H, and a width W. In this illustration, the reference coordinates (X, Y) are represented in a coordinate system of the composite image. In this case, the reference coordinates (x, y) vary in accordance with variation in orientation. Note that, the height H and the width W are fixed values corresponding to a display resolution of the head mounted display 104, such as HD.

In (b) of FIG. 5, the regions in the images captured by the cameras 101A to 101D, which overlap with the display region, are indicated by hatching. In each of the captured images, the region that overlaps with the display region is defined by, for example, reference coordinates (x, y) being coordinates of an upper-left end, a height h, and a width w. In this illustration, the reference coordinates (x, y) are represented in a coordinate system of the captured image.

(c) of FIG. 5 illustrates the cutting-out-target regions determined in the captured images. These cutting-out-target regions are each defined as the region including at least the region that overlaps with the display region, specifically, as a region formed by adding a certain extra region (hereinafter, this certain region is referred to as “pasting-margin region” as appropriate) to an outside of the region that overlaps with the display region. This pasting-margin region is necessary for, for example, (1) knowing a stitching position, (2) removing lens distortion, and (3) performing cutting-out along an oblique cutting line that appears at a time of projective transformation.

The cutting-out-target region in each of the captured images is defined by, for example, reference coordinates (x′, y′) being coordinates of an upper-left end, a height h′, and a width w′. In this illustration, the reference coordinates (x′, y′) are represented in the coordinate system of the captured image. Note that, the cutting-out-target region in each of the captured images may be defined by other information items such as the coordinates of the upper-left end and coordinates of a lower-right end.

Further, the subsequent processing device 103 transmits, to the transmission side via the network, the information items of the cutting-out-target regions in the images captured by the predetermined number of cameras, the cutting-out-target regions overlapping with the display region. In this case, the subsequent processing device 103 transmits the instruction packets containing the cutting-out-target-region information items respectively to the adapters connected to the corresponding cameras.

Still further, the subsequent processing device 103 receives, from the transmission side via the network, the data items of the images of the cutting-out-target regions, which are cut out from the data items of the images captured by the above-mentioned predetermined number of cameras (in this case, all cameras 101A to 101D). Yet further, the subsequent processing device 103 executes not only a stitching process but also a lens-distortion correction process and a projective transformation process when necessary on the received data items of the images of the cutting-out-target regions so as to generate a data item of an image in the composite image, which corresponds to the display region. The subsequent processing device 103 transmits the data item of this image in the composite image to the head mounted display 104.

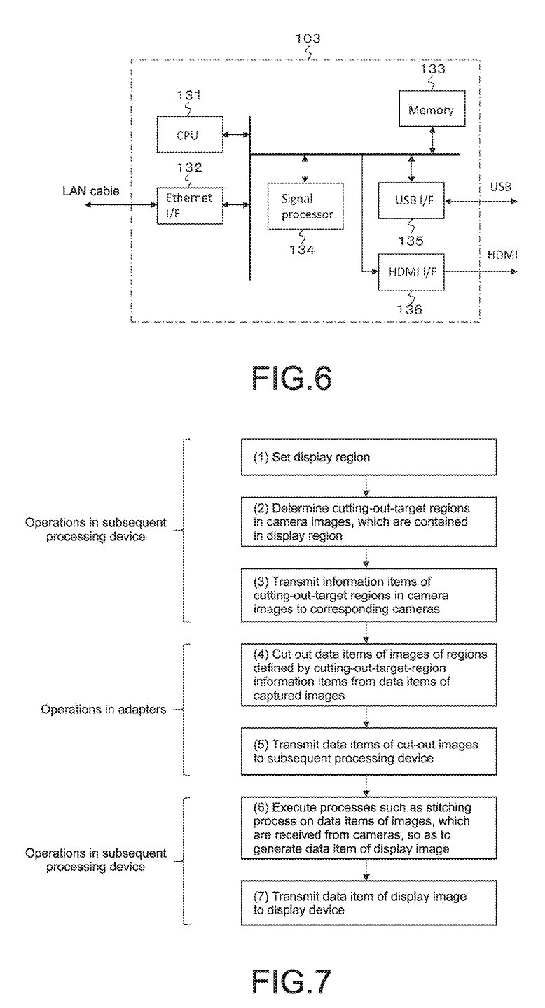

FIG. 6 shows a configuration example of the subsequent processing device 103. The subsequent processing device 103 includes a CPU 131, and an Ethernet interface 132, a memory 133, a signal processor 134, a USB interface 135, and an HDMI interface 136.

The CPU 131 controls operations of the units in the subsequent processing device 103. Further, on the basis of the orientation information that is transmitted as the control information for the display region from the head mounted display 04, the CPU 131 sets the display region in the composite image formed of the images captured by the cameras 101A to 101D. Then, the CPU 131 determines, as the cutting-out-target region, the region including at least the region in each of the images captured by the predetermined number of cameras, the region in each of the images overlapping with this display region (refer to FIG. 5). Note that, the CPU 131 has already grasped to which of pixel coordinates in the images captured by the cameras 101A to 101D pixel coordinates in the composite image formed of the images captured by these cameras correspond, and by which of these cameras the images are captured.

The Ethernet interface 132 is an interface for establishing connection to the network, specifically, to the LAN (Local Area Network). This Ethernet interface 132 transmits, to the transmission side via the network, the information items of the cutting-out-target regions in the images captured by the predetermined number of cameras, the cutting-out-target regions overlapping with the display region. Further, this Ethernet interface 132 receives, via the network, the data items of the images of the cutting-out-target regions, which are cut out from the data items of the images captured by the predetermined number of cameras, and which are transmitted from the transmission side via the network.

The memory 133 stores the data items of the images of the cutting-out-target regions, which are cut out from the data items of the images captured by the predetermined number of cameras, and which are received by the Ethernet interface 132. The signal processor 134 executes not only the stitching process but also the lens-distortion correction process and the projective transformation process when necessary on the data items of the images of the cutting-out-target regions, which are stored in the memory 133, so as to generate the data item of the image in the composite image, which corresponds to the display region. The stitching process to be executed includes extraction of features of the images on the basis of, for example, a general SIFT (Scale-Invariant Feature Transform) algorithm. Note that, in a case where the compression-coding process has been executed on the data items of the images of the cutting-out-target regions, which are stored in the memory 133, this signal processor 134 executes the processes after executing a compression-decoding process.

The USB interface 135 is an interface for performing communication via USB between the subsequent processing device 103 and the head mounted display 104. In this USB communication, the orientation information as the control information for the display region is received from the head mounted display 104. Further, this USB communication may be used instead of the HDMI transmission described below for transmitting the data item of the image in the composite image, which is generated by the signal processor 134, to the head mounted display 104.

The HDMI interface 136 is an interface for performing the HDMI data transmission between the subsequent processing device 103 and the head mounted display 104. In this case, the subsequent processing device 103 corresponds to a source device, and the head mounted display 104 corresponds to a sink device. In this HDMI data transmission, the data item of the image in the composite image, which is generated by the signal processor 134, is transmitted to the head mounted display 104.

FIG. 7 is a schematic flowchart showing the operations in the transmission/reception system 10A shown in FIG. 1. With reference to this flowchart, the operations in the transmission/reception system 10A are briefly described. The transmission/reception system 10A repeatedly executes the following processes (1) to (7) in real time in units of frames for the head mounted display 104.

(1) The subsequent processing device 103 sets, on the basis of the orientation information supplied from the head mounted display 104, the display region in the composite image formed of the images captured by the cameras 101A to 101D (with reference to (a) of FIG. 5). Specifically, the reference coordinates (X, Y) being the coordinates of the upper-left end, the height H, and the width W of the display region in the coordinate system of the composite image.

(2) The subsequent processing device 103 determines the cutting-out-target region in each of the camera images, which is contained in the display region (with reference to (c) of FIG. 5). Specifically, the reference coordinates (x′, y′) being the coordinates of the upper-left end, the height h′, and the width w′ of the cutting-out-target region in the coordinate system of each of the captured images are determined with respect to the cutting-out-target region in each of the camera images.

(3) The subsequent processing device 103 transmits, respectively to the corresponding cameras via the network, the information items of the cutting-out-target regions in the camera images. In this case, the subsequent processing device 103 transmits the instruction packets containing these cutting-out-target-region information items (reference coordinates (x′, y′), heights h′, and widths w′) respectively to the adapters connected to the corresponding cameras.

(4) The adapters 102, which have received the cutting-out-target-region information items from the subsequent processing device 103, cut out the data items of the images of the regions defined by the cutting-out-target-region information items from the data items of the images captured by the corresponding cameras. In this case, not only the regions that overlap with the display region but also data items of images of the pasting-margin regions on the outside of the overlapping regions are cut out together.

(5) The adapters 102, which have received the cutting-out-target-region information items from the subsequent processing device 103, transmit the data items of the images, which are cut out from the data items of the images captured by the corresponding cameras, to the subsequent processing device 103 via the network.

(6) The subsequent processing device 103 executes not only the stitching process but also the lens-distortion correction process and the projective transformation process when necessary on the data items of the images, which are received from the cameras (adapters), so as to generate a data item of a display image (data item of the image in the composite image, which corresponds to the display region).

(7) The subsequent processing device 103 transmits the data item of the display image to the display device, specifically, to the head mounted display 104.

As described above, in the transmission/reception system 10A shown in FIG. 1, not all the data items of the images captured by the cameras 101A to 101D, but only the data items of the images of the cutting-out-target regions from the selected predetermined number of cameras are transmitted from the transmission side to the subsequent processing device 103 via the network on the basis of the information items from the subsequent processing device 103.

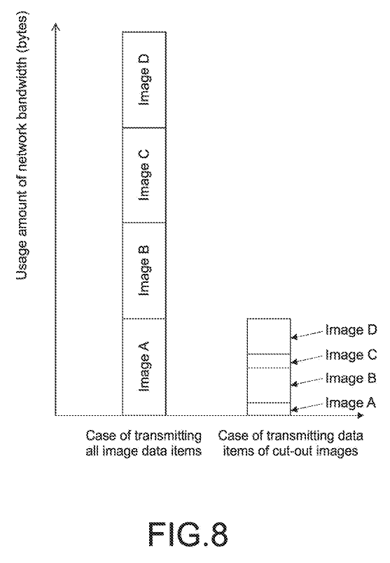

With this, a usage amount of a network bandwidth can be reduced to a usage amount corresponding to the display region. As a result, the network bandwidth can be utilized. FIG. 8 shows a usage amount of the network bandwidth in a case where all the data items of the images captured by the cameras 101A to 101D are transmitted, and a usage amount of the network bandwidth in a case where the data items of the cut-out images are transmitted such that comparison between these usage amounts can be made. Note that, the data items of the cut-out images correspond to those in a case where the display region is set as illustrated in (a) of FIG. 5.

Further, the subsequent processing device 103 generates the data item of the image in the composite image, which corresponds to the display region, by executing the processes such as the stitching process on the data items of the images of the cutting-out-target regions from the cameras, which are received from the transmission side. In other words, the processes such as the stitching process are executed only on the parts corresponding to the display region. With this, processing load can be reduced.

### 2. Modification

Note that, in the example of the embodiment described above, not only the cameras 101A to 101D but also the adapters 102A to 102D corresponding respectively to the cameras 101A to 101D are provided on the transmission side. However, in a case where the cameras 101A to 101D each have a function of the adapter, the adapters to be mounted externally to the cameras can be omitted.

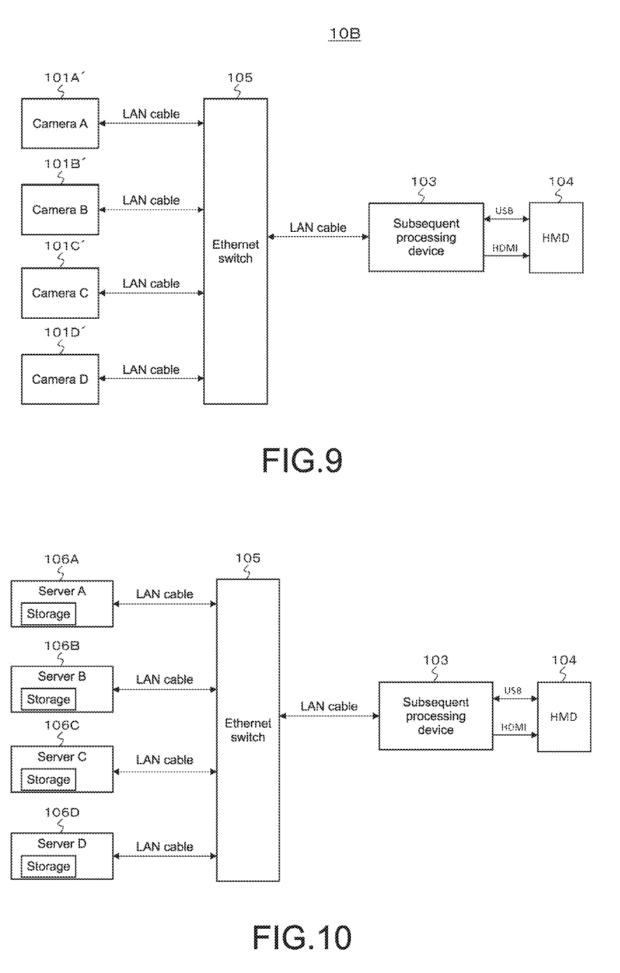

FIG. 9 shows a configuration example of a transmission/reception system 10B in that case. In FIG. 9, units corresponding those in FIG. 1 are denoted by the same reference symbols, and detailed description thereof is omitted. Cameras 101A′ to 101D′ are cameras that respectively have functions of the adapters 102A to 102D in the transmission/reception system 10A shown in FIG. 1.

When the cameras receive the cutting-out-target-region information items from the subsequent processing device 103, the cameras cut out the data items of the images of the cutting-out-target regions from the data items of the captured images, and transmit the data items of these cut-out images to the subsequent processing device 103 via the network. Other configuration features of this transmission/reception system 10B are the same as those of the transmission/reception system 10A shown in FIG. 1. This transmission/reception system 10B also is capable of performing the same operations and providing the same advantages as those of the transmission/reception system 10A shown in FIG. 1.

Further, with regard to the example of the embodiment described above, in which not only the cameras 101A to 101D but also the adapters 102A to 102D corresponding respectively to the cameras 101A to 101D are provided on the transmission side, it is also conceivable to provide functions of the cameras and the functions of the adapters to servers.

FIG. 10 shows a configuration example of a transmission/reception system 10C in that case. In FIG. 10, units corresponding to those in FIG. 1 are denoted by the same reference symbols, and detailed description thereof is omitted. A server 106A to a server 106D include storages that store data items of images captured respectively by imaging with cameras similar to the cameras 101A to 101D in the transmission/reception system 10A of FIG. 1. Further, the server 106A to the server 106D respectively have the functions of the adapters 102A to 102D in the transmission/reception system 10A of FIG. 1.

When the servers receive the cutting-out-target-region information items from the subsequent processing device 103, the servers cut out data items of images of cutting-out-target regions from the data items of the images captured by the corresponding cameras, which are stored in the storages. Then, the servers transmit the data items of these cut-out images to the subsequent processing device 103 via the network. Other configuration features of this transmission/reception system 10C are the same as those of the transmission/reception system 10A shown in FIG. 1. This transmission/reception system 10C also is capable of performing the same operations and providing the same advantages as those of the transmission/reception system 10A shown in FIG. 1.

Further, with regard to the example of the embodiment described above, in which not only the cameras 101A to 101D but also the adapters 102A to 102D corresponding respectively to the cameras 101A to 101D are provided on the transmission side, it is also conceivable to integrate the four adapters 102A to 102D into a single adapter.

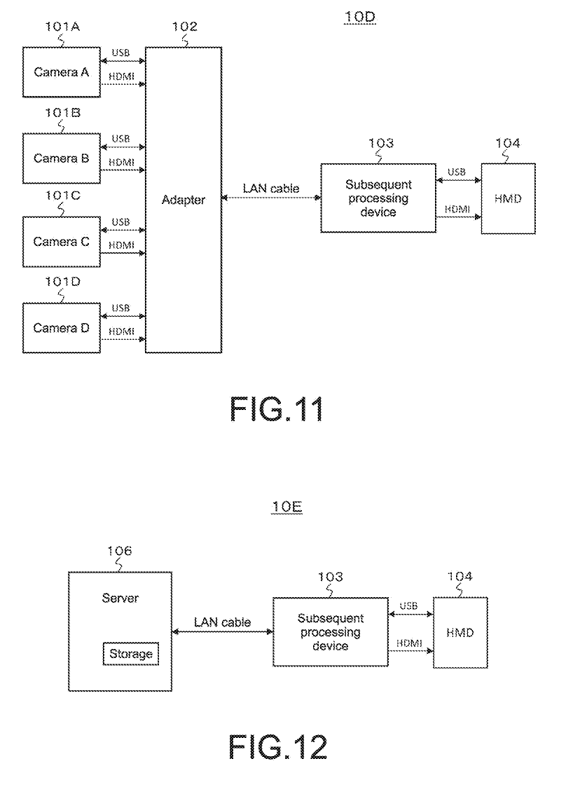

FIG. 11 shows a configuration example of a transmission/reception system 10D in that case. In FIG. 11, units corresponding those in FIG. 1 are denoted by the same reference symbols, and detailed description thereof is omitted. An adapter 102 has the functions of the four adapters 102A to 102D in the transmission/reception system 10A of FIG. 1.

When the adapter 102 receives the cutting-out-target-region information items for the cameras from the subsequent processing device 103, the adapter 102 cuts out the data items of the images of the cutting-out-target regions from the data items of the images captured respectively by the cameras, which are stored in the memory. Then, the adapter 102 transmits the data items of these cut-out images to the subsequent processing device 103 via the network. Other configuration features of this transmission/reception system 10D are the same as those of the transmission/reception system 10A shown in FIG. 1. This transmission/reception system 10D also is capable of performing the same operations and providing the same advantages as those of the transmission/reception system 10A shown in FIG. 1.

Note that, features that are the same as those of the transmission/reception system 10D shown in FIG. 11 are applicable also to the transmission/reception system 10C shown in FIG. 10. FIG. 12 shows a configuration example of a transmission/reception system 10E in that case. In FIG. 12, units corresponding to those in FIG. 10 are denoted by the same reference symbols, and detailed description thereof is omitted. A server 106 has functions of the four servers 106A to 106D in the transmission/reception system 10C of FIG. 10.

When the server 106 receives the cutting-out-target-region information items for the cameras from the subsequent processing device 103, the server 106 cuts out data items of images of cutting-out-target regions from the data items of the images captured by the respective cameras, which are stored in the storage. Then, the server 106 transmits the data items of these cut-out images to the subsequent processing device 103 via the network. Other configuration features of this transmission/reception system 10E are the same as those of the transmission/reception system 10C shown in FIG. 10. This transmission/reception system 10E also is capable of performing the same operations and providing the same advantages as those of the transmission/reception system 10C shown in FIG. 10.

Further, in the example of the embodiment described above, the transmission side and the reception side are connected to each other via the wired network connection with use of the LAN cable. However, it is also conceivable to establish a wireless network connection therebetween.

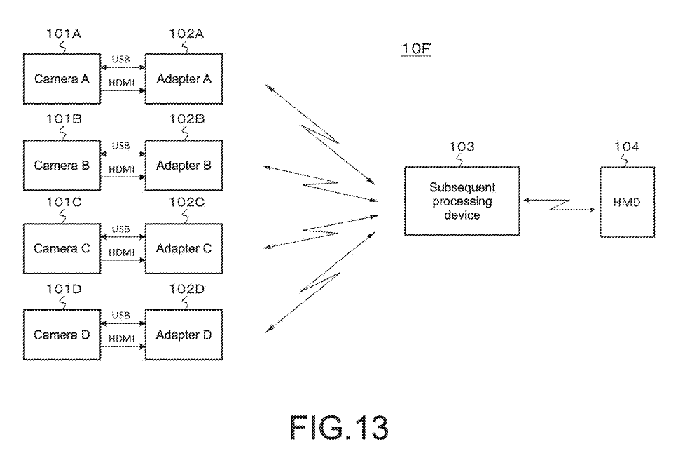

FIG. 13 shows a configuration example of a transmission/reception system 10F in that case. In FIG. 13, units corresponding those in FIG. 1 are denoted by the same reference symbols, and detailed description thereof is omitted. In this case, the adapters 102A to 102D and the subsequent processing device 103 each have a wireless LAN (WiFi) function. Further, in this example, the subsequent processing device 103 and the head mounted display 104 are connected to each other in a wireless manner. This transmission/reception system 10F also is capable of performing the same operations and providing the same advantages as those of the transmission/reception system 10A shown in FIG. 1.

Note that, although not described in detail, the configuration example of the transmission/reception system 10F shown in FIG. 13, which is an example corresponding to the transmission/reception system 10A shown in FIG. 1, may correspond also to the transmission/reception system 10B shown in FIG. 9, the transmission/reception system 10C shown in FIG. 10, the transmission/reception system 10D shown in FIG. 11, and the transmission/reception system 10E shown in FIG. 12.

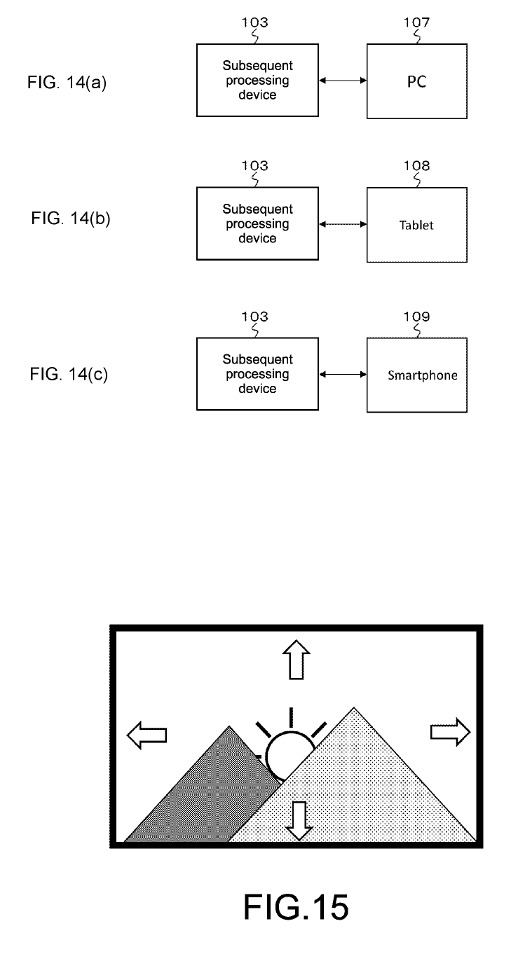

Further, in the example of the embodiment described above, the head mounted display 104 is connected as the display device to the subsequent processing device 103. However, the display device is not limited to this head mounted display 104. For example, (a) of FIG. 14 shows an example in which the display device is a personal computer 107, (b) of FIG. 14 shows an example in which the display device is a tablet 108, and (c) of FIG. 14 shows an example in which the display device is a smartphone 109.

FIG. 15 illustrates an example of a displayed screen in the cases where the display device is the personal computer 107, the tablet 108, the smartphone 109, or the like. By touching or mouse-clicking the vertical and the horizontal arrows, the displayed screen can be scrolled. In this case, from the personal computer 107, the tablet 108, the smartphone 109, or the like to the subsequent processing device 103, movement information items based on the touch operation or the mouse-click operation by a user are supplied as the control information items for the display region. On the basis of such movement information items, the subsequent processing device 103 moves a setting position of the display region.

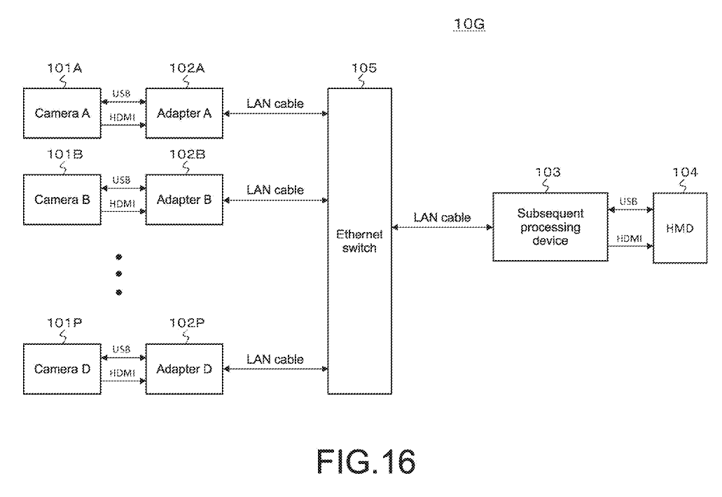

In addition, in the example of the embodiment described above, the data items of the images captured by the four cameras 101A to 101D are processed. However, the number of the cameras is not limited to four, and another configuration example in which data items of images captured by another number of cameras are processed is also conceivable. For example, FIG. 16 shows a configuration example of a transmission/reception system 10G in which data items of images captured by sixteen cameras 101A to 101P are processed.

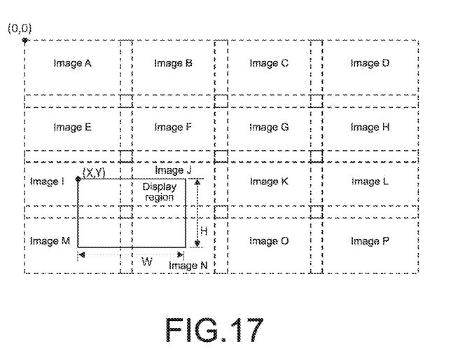

In this case, not only the cameras 101A to 101P but also adapters 102A to 102P corresponding respectively to the cameras 101A to 101P are provided on the transmission side. FIG. 17 illustrates an example of a display region that is set in a composite image in that case. In this illustration, images A to P are images captured by the cameras 101A to 101P, respectively. In this case, four cameras, specifically, a camera 1011, a camera 101M, a camera 101J, and a camera 101N are selected as the predetermined number of cameras.

Note that, although not described in detail, the configuration example of the transmission/reception system 10G shown in FIG. 16, which is an example corresponding to the transmission/reception system 10A shown in FIG. 1, may correspond also to the transmission/reception system 10B shown in FIG. 9, the transmission/reception system 10C shown in FIG. 10, the transmission/reception system 10D shown in FIG. 11, the transmission/reception system 10E shown in FIG. 12, and the transmission/reception system 10F shown in FIG. 13.

Further, in the example of the embodiment described above, the data items of the images of the cutting-out-target regions from the predetermined number of cameras are transmitted from the transmission side to the subsequent processing device 103, and not only the stitching process but also the lens-distortion correction process and the projective transformation process are executed when necessary in the subsequent processing device 103 on the data items of the images of these cutting-out-target regions from the predetermined number of cameras such that the data item of the image in the composite image, which corresponds to the display region, is generated. However, it is also conceivable to execute the processes such as the stitching process on the transmission side, and then to transmit the data item of the image in the composite image after these processes from the transmission side to the subsequent processing device 103. In this case, the processes such as the stitching process need not be executed in the subsequent processing device 103, and hence processing load can be significantly reduced.

Further, although not described above, it is also conceivable to provide the function of the subsequent processing device 103 to the display devices such as the head mounted display 104. In that case, the subsequent processing device 103 need not be provided independently of the display device, and hence the configuration on the reception side can be simplified.

Note that, the present technology may also provide the following configurations.

(1) A transmission device, including:
a storage unit that stores data items of images captured by imaging with a plurality of cameras in a manner that adjacent ones of the captured images overlap with each other;
an information reception unit that receives, from an external device via a network, cutting-out-target-region information items for a predetermined number of cameras selected from the plurality of cameras; and
an image-data transmission unit that
   cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit, and
   transmits the data items of the images of the cutting-out-target regions to the external device via the network.

(2) The transmission device according to Item (1), in which
the image-data transmission unit transmits, to the external device, the data items of the images of the cutting-out-target regions from the predetermined number of cameras after execution of a compression-coding process on the data items of the images of the cutting-out-target regions.

(3) A transmission method including an information reception step of receiving, from an external device via a network, cutting-out-target-region information items for a predetermined number of cameras selected from a plurality of cameras, the plurality of cameras performing imaging in a manner that adjacent ones of captured images overlap with each other,
the transmission method further including
   an image-data transmission step of causing an image-data transmission unit
      to cut out, on the basis of the cutting-out-target-region information items for the predetermined number of cameras, data items of images of cutting-out-target regions from corresponding ones of data items of the images captured by the plurality of cameras, and
      to transmit the data items of the images of the cutting-out-target regions to the external device via the network.

(4) A transmission device, including:
a plurality of cameras that perform imaging in a manner that adjacent ones of captured images overlap with each other; and
a plurality of adapters provided to correspond respectively to the plurality of cameras,
the plurality of adapters respectively including
   storage units that store data items of the images captured by imaging with corresponding ones of the plurality of cameras,
   information reception units that receive, from an external device via a network, cutting-out-target-region information items for the corresponding ones of the plurality of cameras, and
   image-data transmission units that
      cut out, on the basis of the cutting-out-target-region information items, data items of images of cutting-out-target regions from corresponding ones of the data items of the captured images, the data items of the captured images being stored in the storage units, and
      transmit the data items of the images of the cutting-out-target regions to the external device via the network.

(5) A transmission device, including
a plurality of cameras that perform imaging in a manner that adjacent ones of captured images overlap with each other,
the plurality of cameras respectively including
   information reception units that receive cutting-out-target-region information items from an external device via a network, and
   image-data transmission units that
      cut out, on the basis of the cutting-out-target-region information items, data items of images of cutting-out-target regions from data items of the captured images, and
      transmit the data items of the images of the cutting-out-target regions to the external device via the network.

(6) A transmission device, including
a plurality of servers provided to correspond respectively to a plurality of cameras that perform imaging in a manner that adjacent ones of captured images overlap with each other,
the plurality of servers respectively including
   storage units that store data items of the images captured by imaging with corresponding ones of the plurality of cameras,
   information reception units that receive, from an external device via a network, cutting-out-target-region information items for the corresponding ones of the plurality of cameras, and
   image-data transmission units that
      cut out, on the basis of the cutting-out-target-region information items, data items of images of cutting-out-target regions from the data items of the captured images, the data items of the captured images being stored in the storage units, and
      transmit the data items of the images of the cutting-out-target regions to the external device via the network.

(7) A reception device, including:
a cutting-out-target-region determination unit that
   sets a display region in a composite image formed of images captured by imaging with a plurality of cameras in a manner that adjacent ones of the captured images overlap with each other, and
   determines regions in images captured by a predetermined number of cameras as cutting-out-target regions, the regions in the captured images including at least regions that overlap with the display region;
an information transmission unit that transmits cutting-out-target-region information items for the predetermined number of cameras to an external device via a network;
an image-data reception unit that receives, from the external device via the network, data items of images of the cutting-out-target regions from the predetermined number of cameras; and
an image-data processing unit that executes a stitching process on the received data items of the images of the cutting-out-target regions from the predetermined number of cameras to generate a data item of an image in the composite image, the image in the composite image corresponding to the display region.

(8) The reception device according to claim 7, in which
the cutting-out-target-region determination unit sets the display region on the basis of control information for the display region, the control information being supplied from a display device that displays an image generated from the data item of the image in the composite image.

(9) The reception device according to Item (8), in which
the display device is a head mounted display, and
the control information for the display region is orientation information.

(10) The reception device according to Item (8), in which
the display device is
   a personal computer,
   a tablet, or
   a smartphone, and
the control information for the display region is movement information based on an operation by a user.

(11) The reception device according to any one of Items (7) to (10), in which
the received data items of the images of the cutting-out-target regions from the predetermined number of cameras have been subjected to a compression-coding process, and
the image-data processing unit executes a compression-decoding process on the data items of the images of the cutting-out-target regions from the predetermined number of cameras, and then executes the stitching process to generate the data item of the image in the composite image, the image in the composite image corresponding to the display region.

(12) A reception method, including:
a cutting-out-target-region determination step of
   setting a display region in a composite image formed of images captured by imaging with a plurality of cameras in a manner that adjacent ones of the captured images overlap with each other, and
   determining regions in images captured by a predetermined number of cameras as cutting-out-target regions, the regions in the captured images including at least regions that overlap with the display region;
an information transmission step of transmitting cutting-out-target-region information items for the predetermined number of cameras to an external device via a network;
an image-data reception step of causing an image-data reception unit to receive, from the external device, data items of images of the cutting-out-target regions from the predetermined number of cameras; and
an image-data processing step of executing a stitching process on the data items of the images of the cutting-out-target regions from the predetermined number of cameras to generate a data item of an image in the composite image, the image in the composite image corresponding to the display region.

(13) A transmission/reception system, including:
a transmission device; and
a reception device connected to the transmission device via a network,
the transmission device including
   a storage unit that stores data items of images captured by imaging with a plurality of cameras in a manner that adjacent ones of the captured images overlap with each other,
   an information reception unit that receives, from the reception device via the network, cutting-out-target-region information items for a predetermined number of cameras selected from the plurality of cameras, and
   an image-data transmission unit that
      cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit, and
      transmits the data items of the images of the cutting-out-target regions to the reception device via the network,
the reception device including
   a cutting-out-target-region determination unit that
      sets a display region in a composite image formed of the images captured by the plurality of cameras, and
      determines regions in images captured by the predetermined number of cameras as the cutting-out-target regions, the regions in the captured images including at least regions that overlap with the display region,
   an information transmission unit that transmits the cutting-out-target-region information items for the predetermined number of cameras to the transmission device via the network,
   an image-data reception unit that receives, from the transmission device via the network, the data items of the images of the cutting-out-target regions from the predetermined number of cameras, and
   an image-data processing unit that executes a stitching process on the received data items of the images of the cutting-out-target regions from the predetermined number of cameras to generate a data item of an image in the composite image, the image in the composite image corresponding to the display region.

(14) A transmission device, including:
a storage unit that stores data items of images captured by imaging with a plurality of cameras in a manner that adjacent ones of the captured images overlap with each other;
an information reception unit that receives, from an external device via a network, cutting-out-target-region information items for a predetermined number of cameras selected from the plurality of cameras;
an image-data cutting-out unit that cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit;
an image-data processing unit that executes a stitching process on the data items of the images of the cutting-out-target regions from the predetermined number of cameras to generate a data item of an image in a composite image; and
an image-data transmission unit that transmits the data item of the image in the composite image to the external device via the network.

(15) A reception device, including:
a cutting-out-target-region determination unit that
   sets a display region in a composite image formed of images captured by imaging with a plurality of cameras in a manner that adjacent ones of the captured images overlap with each other, and
   determines regions in images captured by a predetermined number of cameras as cutting-out-target regions, the regions in the captured images including at least regions that overlap with the display region;
an information transmission unit that transmits cutting-out-target-region information items for the predetermined number of cameras to an external device via a network; and
an image-data reception unit that receives, from the external device via the network, a data item of an image in the composite image, the image in the composite image having been generated by execution of a stitching process on data items of images of the cutting-out-target regions from the predetermined number of cameras.

### REFERENCE SIGNS LIST

10A to 10G transmission/reception system
101A to 101P, 101A′ to 101D′ camera
102, 102A to 102D, 102A′ to 102D′ adapter
103 subsequent processing device
104 head mounted display
105 Ethernet switch
106, 106A to 106D server
107 personal computer
108 tablet
109 smartphone
121 CPU
122 USB interface
123 HDMI interface
124 memory
125 encoder
126 Ethernet interface
131 CPU
132 Ethernet interface
133 memory
134 signal processor
135 USB interface
136 HDMI interface

1. A transmission device, comprising:
a storage unit that stores data items of images captured by imaging with a plurality of cameras in a manner that adjacent ones of the captured images overlap with each other;
an information reception unit that receives, from an external device via a network, cutting-out-target-region information items for a predetermined number of cameras selected from the plurality of cameras; and
an image-data transmission unit that
cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit, and
transmits the data items of the images of the cutting-out-target regions to the external device via the network.

2. The transmission device according to claim 1, wherein
the image-data transmission unit transmits, to the external device, the data items of the images of the cutting-out-target regions from the predetermined number of cameras after execution of a compression-coding process on the data items of the images of the cutting-out-target regions.

3. A transmission method including an information reception step of receiving, from an external device via a network, cutting-out-target-region information items for a predetermined number of cameras selected from a plurality of cameras, the plurality of cameras performing imaging in a manner that adjacent ones of captured images overlap with each other,
the transmission method further comprising
an image-data transmission step of causing an image-data transmission unit
to cut out, on the basis of the cutting-out-target-region information items for the predetermined number of cameras, data items of images of cutting-out-target regions from corresponding ones of data items of the images captured by the plurality of cameras, and
to transmit the data items of the images of the cutting-out-target regions to the external device via the network.

4. A transmission device, comprising:
a plurality of cameras that perform imaging in a manner that adjacent ones of captured images overlap with each other; and
a plurality of adapters provided to correspond respectively to the plurality of cameras,
the plurality of adapters respectively including
storage units that store data items of the images captured by imaging with corresponding ones of the plurality of cameras,
information reception units that receive, from an external device via a network, cutting-out-target-region information items for the corresponding ones of the plurality of cameras, and
image-data transmission units that
cut out, on the basis of the cutting-out-target-region information items, data items of images of cutting-out-target regions from corresponding ones of the data items of the captured images, the data items of the captured images being stored in the storage units, and
transmit the data items of the images of the cutting-out-target regions to the external device via the network.

5. A transmission device, comprising
a plurality of cameras that perform imaging in a manner that adjacent ones of captured images overlap with each other,
the plurality of cameras respectively including
information reception units that receive cutting-out-target-region information items from an external device via a network, and
image-data transmission units that
cut out, on the basis of the cutting-out-target-region information items, data items of images of cutting-out-target regions from data items of the captured images, and
transmit the data items of the images of the cutting-out-target regions to the external device via the network.

6. A transmission device, comprising
a plurality of servers provided to correspond respectively to a plurality of cameras that perform imaging in a manner that adjacent ones of captured images overlap with each other,
the plurality of servers respectively including
storage units that store data items of the images captured by imaging with corresponding ones of the plurality of cameras,
information reception units that receive, from an external device via a network, cutting-out-target-region information items for the corresponding ones of the plurality of cameras, and
image-data transmission units that
cut out, on the basis of the cutting-out-target-region information items, data items of images of cutting-out-target regions from the data items of the captured images, the data items of the captured images being stored in the storage units, and
transmit the data items of the images of the cutting-out-target regions to the external device via the network.

7. A reception device, comprising:
a cutting-out-target-region determination unit that
sets a display region in a composite image formed of images captured by imaging with a plurality of cameras in a manner that adjacent ones of the captured images overlap with each other, and
determines regions in images captured by a predetermined number of cameras as cutting-out-target regions, the regions in the captured images including at least regions that overlap with the display region;
an information transmission unit that transmits cutting-out-target-region information items for the predetermined number of cameras to an external device via a network;
an image-data reception unit that receives, from the external device via the network, data items of images of the cutting-out-target regions from the predetermined number of cameras; and
an image-data processing unit that executes a stitching process on the received data items of the images of the cutting-out-target regions from the predetermined number of cameras to generate a data item of an image in the composite image, the image in the composite image corresponding to the display region.

8. The reception device according to claim 7, wherein
the cutting-out-target-region determination unit sets the display region on the basis of control information for the display region, the control information being supplied from a display device that displays an image generated from the data item of the image in the composite image.

9. The reception device according to claim 8, wherein
the display device is a head mounted display, and
the control information for the display region is orientation information.

10. The reception device according to claim 8, wherein
the display device is
a personal computer,
a tablet, or
a smartphone, and
the control information for the display region is movement information based on an operation by a user.

11. The reception device according to claim 7, wherein
the received data items of the images of the cutting-out-target regions from the predetermined number of cameras have been subjected to a compression-coding process, and
the image-data processing unit executes a compression-decoding process on the data items of the images of the cutting-out-target regions from the predetermined number of cameras, and then executes the stitching process to generate the data item of the image in the composite image, the image in the composite image corresponding to the display region.

12. A reception method, comprising:
a cutting-out-target-region determination step of
setting a display region in a composite image formed of images captured by imaging with a plurality of cameras in a manner that adjacent ones of the captured images overlap with each other, and
determining regions in images captured by a predetermined number of cameras as cutting-out-target regions, the regions in the captured images including at least regions that overlap with the display region;
an information transmission step of transmitting cutting-out-target-region information items for the predetermined number of cameras to an external device via a network;
an image-data reception step of causing an image-data reception unit to receive, from the external device, data items of images of the cutting-out-target regions from the predetermined number of cameras; and
an image-data processing step of executing a stitching process on the data items of the images of the cutting-out-target regions from the predetermined number of cameras to generate a data item of an image in the composite image, the image in the composite image corresponding to the display region.

13. A transmission/reception system, comprising:
a transmission device; and
a reception device connected to the transmission device via a network,
the transmission device including
a storage unit that stores data items of images captured by imaging with a plurality of cameras in a manner that adjacent ones of the captured images overlap with each other,
an information reception unit that receives, from the reception device via the network, cutting-out-target-region information items for a predetermined number of cameras selected from the plurality of cameras, and
an image-data transmission unit that
cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit, and
transmits the data items of the images of the cutting-out-target regions to the reception device via the network,
the reception device including
a cutting-out-target-region determination unit that
sets a display region in a composite image formed of the images captured by the plurality of cameras, and
determines regions in images captured by the predetermined number of cameras as the cutting-out-target regions, the regions in the captured images including at least regions that overlap with the display region,
an information transmission unit that transmits the cutting-out-target-region information items for the predetermined number of cameras to the transmission device via the network,
an image-data reception unit that receives, from the transmission device via the network, the data items of the images of the cutting-out-target regions from the predetermined number of cameras, and
an image-data processing unit that executes a stitching process on the received data items of the images of the cutting-out-target regions from the predetermined number of cameras to generate a data item of an image in the composite image, the image in the composite image corresponding to the display region.

14. A transmission device, comprising:
a storage unit that stores data items of images captured by imaging with a plurality of cameras in a manner that adjacent ones of the captured images overlap with each other;
an information reception unit that receives, from an external device via a network, cutting-out-target-region information items for a predetermined number of cameras selected from the plurality of cameras;
an image-data cutting-out unit that cuts out, on the basis of the cutting-out-target-region information items for the predetermined number of cameras, data items of images of cutting-out-target regions from corresponding ones of the data items of the images captured by the plurality of cameras, the data items of the captured images being stored in the storage unit;
an image-data processing unit that executes a stitching process on the data items of the images of the cutting-out-target regions from the predetermined number of cameras to generate a data item of an image in a composite image; and
an image-data transmission unit that transmits the data item of the image in the composite image to the external device via the network.

15. A reception device, comprising:
a cutting-out-target-region determination unit that
sets a display region in a composite image formed of images captured by imaging with a plurality of cameras in a manner that adjacent ones of the captured images overlap with each other, and
determines regions in images captured by a predetermined number of cameras as cutting-out-target regions, the regions in the captured images including at least regions that overlap with the display region;
an information transmission unit that transmits cutting-out-target-region information items for the predetermined number of cameras to an external device via a network; and
an image-data reception unit that receives, from the external device via the network, a data item of an image in the composite image, the image in the composite image having been generated by execution of a stitching process on data items of images of the cutting-out-target regions from the predetermined number of cameras.
